(19) United States
(12) Patent Application Publication
(10) Pub. No.: US 2009/0290508 A1
(43) Pub. Date: Nov. 26, 2009

(54) Method for optimizing network "Point of Presence" locations

(75) Inventors: Sarat Puthenpura, Berkeley Heights, NJ (US); David G. Belanger, Hillsborough, NJ (US); Arun Jotshi, Lake Hiawatha, NJ (US); Sam Houston Parker, Cranbury, NJ (US); Wenjie Zhao, Princeton, NJ (US)

Correspondence Address: AT&T LEGAL DEPARTMENT - Koba;ATTN: PATENT DOCKETING, ROOM 2A-207, ONE AT&T WAY, BEDMINSTER, NJ, 07921, US

(73) Assignee: AT&T Labs, Inc.

(21) Appl. No.: 12/154,352

(22) Filed: May 22, 2008

(51) Int. Cl. H04L 12/28

(52) U.S. Cl. 370/254

(57) ABSTRACT

A methodology for optimizing the placement of network “Points of Presence” (POPs) across the carrier's entire network (i.e., a “global” solution”) utilizes carefully constructed customer clustering and simulated annealing methodology to create a cost-efficient solution. The customer base is first partitioned into a plurality of clusters such that the customers within each cluster are closer to its centroid than the centroid of any other cluster (e.g., applying the k-means clustering algorithm or any other suitable method of partitioning the customer base). A linear algorithm process is used to minimize the costs associated with the number of placement of POPs within each cluster. A simulated annealing (SA) process is then used to iterate the entire set of potential POP locations until a compact, steady-state solution is achieved (or, alternatively, until a given number of iterations has been performed). In a preferred embodiment, a number of iterations are performed at each “temperature” in the simulating annealing process to further improve the result (this iterative process referred to in the art as “intensification”).

### TECHNICAL FIELD

The present invention relates to a methodology for optimizing the placement of network “Points of Presence” (POPs) across the carrier's entire network (i.e., a “global” solution“) utilizing carefully constructed customer clustering and simulated annealing methodology to create a cost-efficient solution.

### BACKGROUND OF THE INVENTION

A typical telecommunications network includes transmission components, switching components and facilities for maintaining equipment,. Transmission components or links are the media used to transmit signals. Switching components or nodes include transmitters and receivers for voice and data and routers for routing using circuit-switching techniques. As telecommunications network topology has evolved, a network carrier (also referred to as an inter-exchange carrier, or IXC) supports and maintains an extensive interconnection of high capacity trunks and facilities across a entire country, or a large region thereof. Within a more localized area, one or more “regional” telecommunications companies provides direct line service (either leased or dedicated) to individual customers (either business customers or residential customers). At one or more “Points of Presence” (POPs) within the regions, the network carrier interfaces with the end-user customer served by the access supplier. The POP facility is owned/controlled by the network carrier and houses the electronic/optic components, computers and the like which are required to provide communication connections between the access supplier and the network carrier.

For the most part, the decision regarding where to locate a network carrier's various POPs has occurred on an ad hoc basis, with one or more network service planners reviewing the customer demographics in a certain area and creating, by brute force, a deployment of one or more POPs that can serve the area being studied.

Clearly, this method is inefficient and subject to errors in POP location determination. Regional network engineers recommend the location of potential POPs based on localized demand information and ad-hoc business rules. Average distance from the customer premise to potential POP locations and customer density measurements and predictions are frequently used as key parameters in POP location decisions.

As the customer base chums over time, POP locations should be re-examined regularly and changes should be made according to changes in customer demand and its geographical distribution. A manual process is also typically used by network planners to make POP location adjustments (“add”, “move” and “close”) on a localized based (one city/region at a time), usually resulting in sub-optimal POP change recommendations.

Thus, a need remains in the art for a more efficient method of analyzing POP locations for a network carrier, preferably a method that allows for a ‘global’ analysis of all POP locations across the network, eliminating the prior type of sub-optimal, localized decision making.

### SUMMARY OF THE INVENTION

The needs remaining in the prior art are addressed by the present invention which relates to a methodology for optimizing the placement of network “Points of Presence” (POPs) across the carrier's entire network (i.e., a “global” solution”) utilizing carefully constructed customer clustering and simulated annealing methodology to create a cost-efficient solution.

In accordance with the present invention, the enormity of the global optimization problem is addressed by first partitioning the customer base into a plurality of clusters such that the customers within each cluster are closer to its centroid than the centroid of any other cluster (e.g., applying the k-means clustering algorithm or any other suitable method of partitioning the customer base). The partitioning of the problem in this manner allows for a locally-optimal solution of the POP location problem to be obtained for each cluster.

A linear algorithm process is used to minimize the costs associated with the number of placement of POPs within each cluster. If desired, variables associated with future expansion may be included in the decision-making at this point. As a result of this step, an initial set of “potential” POP locations are identified, with each customer circuit identified as homing on only one POP location, using only one selected access provider (out of a known set of access suppliers).

At this point, the result will remain sub-optimal from an overall, global view. In accordance with the present invention, a simulated annealing (SA) process is then used to iterate the entire set of potential POP locations until a compact, steady-state solution is achieved (or, alternatively, until a given number of iterations has been performed). In a preferred embodiment, a number of iterations are performed at each “temperature” in the simulating annealing process to further improve the result (this iterative process referred to in the art as “intensification”).

It is an aspect of the present invention that the use of clustering and simulated annealing allows for different scenarios to be evaluated in real time, allowing for the network service provider to more efficiently determine the most cost-effective allocation of POP facility resources to serve an ever-changing customer base.

Other and further aspects of the present invention will become apparent during the course of the following discussion and by reference to the accompanying drawings.

### BRIEF DESCRIPTION OF THE DRAWINGS

Referring now to the drawings,

FIG. 1 illustrates an exemplary telecommunications network architecture within which the optimization methodology of the present invention may be employed:

FIG. 2 is a basic flowchart of the overall optimization methodology of the present invention;

FIG. 3 is a detailed flowchart of an exemplary method for grouping customer circuits into manageable partitions, in this case using the k-means clustering process;

FIG. 4 is a detailed flowchart of the simulated annealing (SA) process used to globally improve the “per-cluster” optimized results for POP facility location;

FIG. 5 is a flowchart of an exemplary method of creating a neighboring result for use during the comparison phase of the simulated annealing process of FIG. 4; and

FIGS. 6(a) and 6(b) contain network topologies as existing “before” and “after” the application of the optimization methodology of the present invention.

### DETAILED DESCRIPTION

As mentioned above, a telecommunications carrier needs to interface with other network carriers in order to exchange network traffic and properly service its customer base. “Points-of-Presence” (POPs) for a given carrier are the network locations where such interface occurs. The number and location of the POP facilities directly impact the telecommunications carrier's network transport costs in terms of both the leasing costs it must pay to other carriers and its own “backbone” transport cost (the term “backbone” refers to the transport of network traffic among a carrier's POPs). Moreover, the POPs can be configured to different levels of capability and capacity to support various transport technologies, network equipment types, products and services.

In particular, the number of POPs, their location and type needs to be determined by the geographical distribution of the carrier's customer base (and, preferably, includes future forecasts of customer geographic locations), the service level demands of the customer, and the like. Additionally, the tariff structure associated with each access supplier (the entity that connects the customer to the POP), evolution of transport technology, service reliability, network node equipment and backbone link cost all need to be considered when determining an optimal POP architecture.

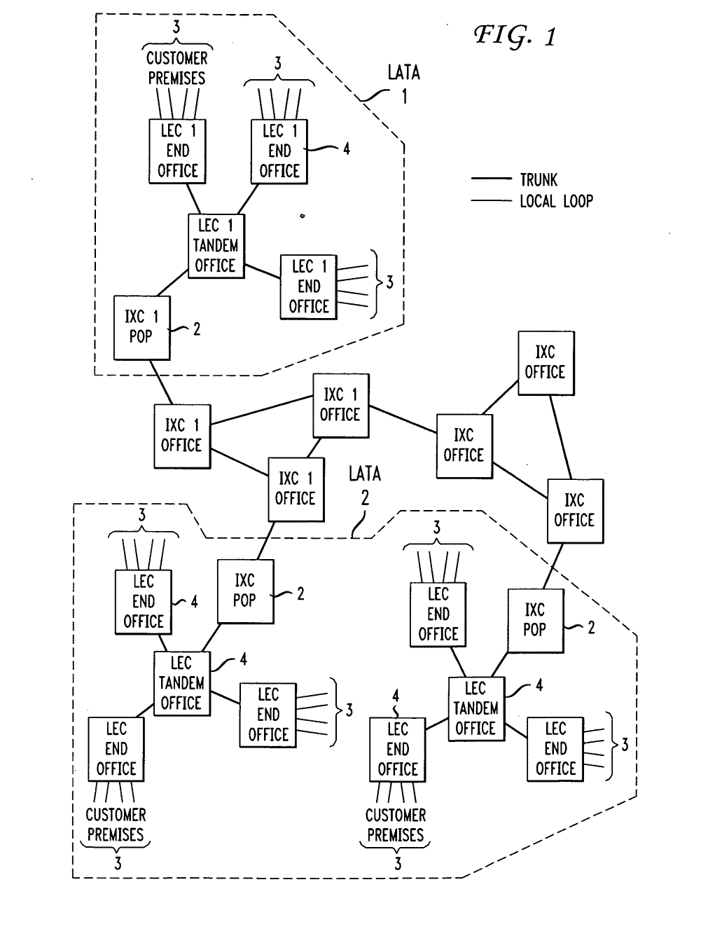

For the sake of clarity, FIG. 1 illustrates an exemplary network architecture arrangement within which the POP location optimization methodology of the present invention may be employed. It is to be understood that this illustration has been simplified for the sake of clarity, showing only those elements associated with the implementation of the present invention. As shown, a network carrier (denoted IXC 1 in the drawing) has a plurality of switches and trunks that are interconnected across a large area, in most cases, across an entire country. Different regions within the country interconnect with IXC 1 via a set of POPs 2, distributed in the manner illustrated in FIG. 1. The end-user customers 3 ultimately communication with IXC1 via POPs 2 over communication lines provided by various access suppliers 4.

Obviously, the optimal selection and location of network POPs is vitally important to a carrier's overall business. In addition to its critical impact on the carrier's network cost structure, it strongly influences a carrier's market competitiveness.

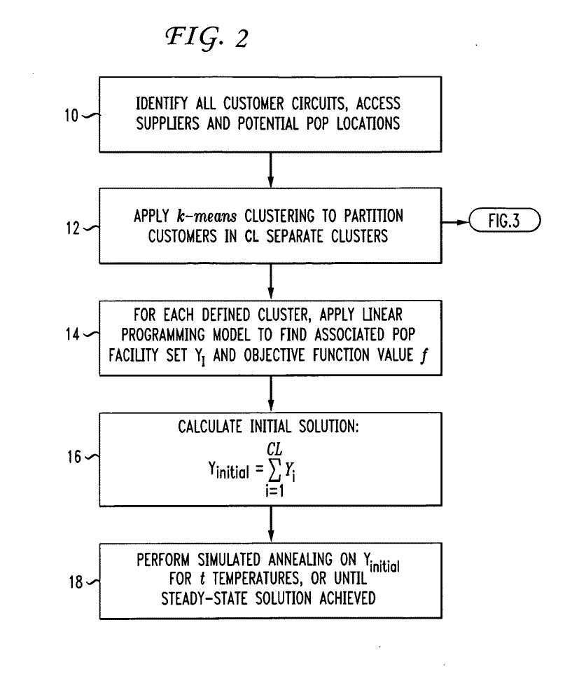

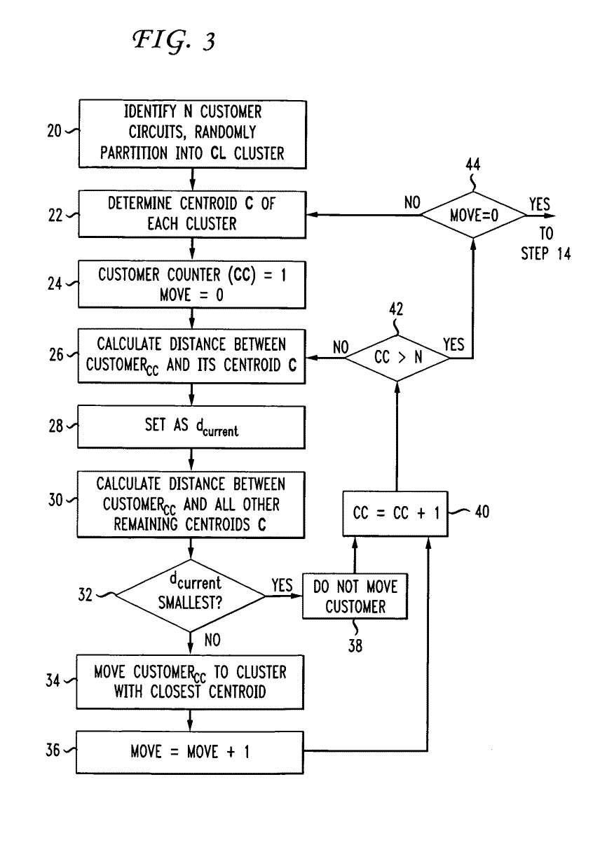

The methodology of the present invention addresses the problem of determining the optimum location of POPs in the manner outlined in the flowchart of FIG. 2. The initial step of identifying the complete population of customers, access suppliers and potential POP locations is shown as step 10 in the flowchart of FIG. 2. Inasmuch as the total number of customers, access suppliers and POP locations (and various solutions of combining these) is overwhelmingly large, it becomes computationally prohibitive to solve problems using commercially-available software. Thus, in accordance with the present invention, the next step in the process of the present invention is to apply the k-means clustering algorithm (step 12) to partition the customer base into a plurality of CL clusters. The details of implementing the k-means clustering process are shown in a separate flowchart in FIG. 3.

The clusters are sized so that conventional software processes can be used to define the optimal access supplier/POP location combinations for the small set of customers within each cluster (step 14). In particular, a linear programming model is used as discussed in detail below, to process the data associated with a particular cluster, finding a minimum solution based on the costs (on-going and recurring) for customers, access suppliers and potential POP facility locations within that cluster. For each cluster i, the set Yᵢ is used to denote the POP locations defined for that cluster.

The next step in the process is merely to combine the sets of “local” POP location solutions to form an initial global solution for the POP location optimization problem, defined as shown below and illustrated in step 16:

$${Y}_{initial} = {\sum }_{i = 1}^{CL} {Y}_{i} .$$

While the results of step 16 will yield a “solution” to the problem of POP location, it will in most cases not generate the most cost effective solution from an overall network point of view.

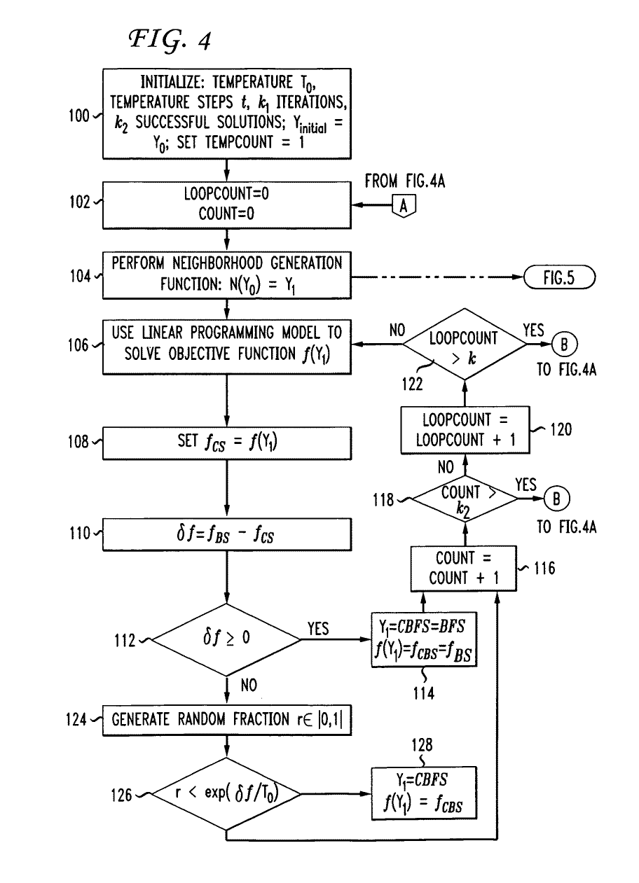

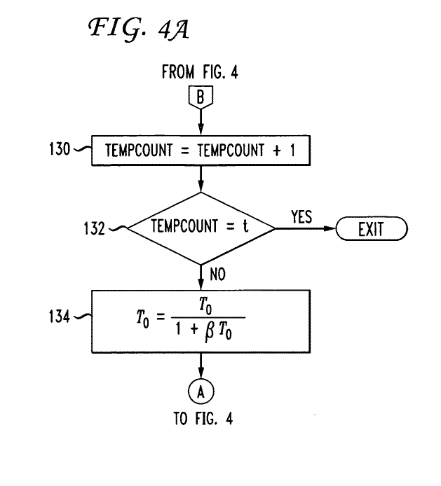

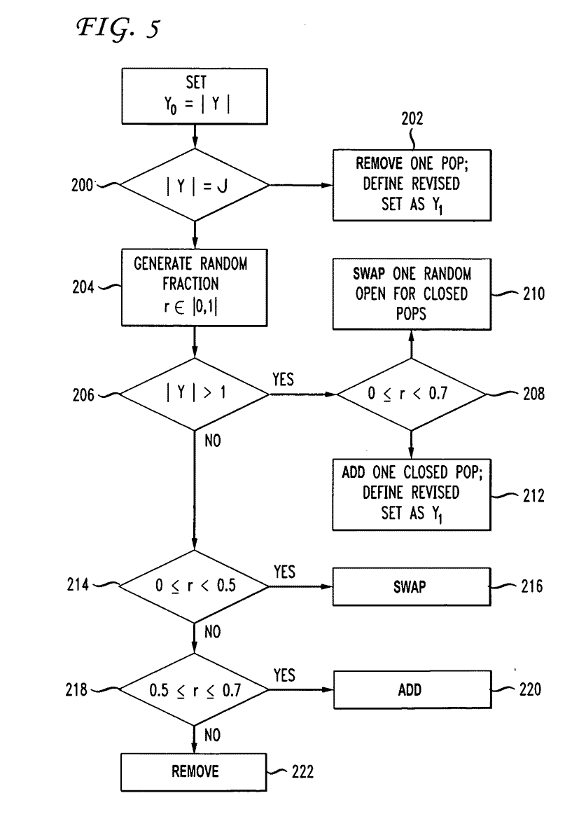

Therefore, in accordance with the present invention, a simulated annealing process is applied to the initial solution (step 18) to further manipulate the results in an effort to reduce the overall costs to the carrier. Simulated annealing (SA) is a probabilistic meta-algorithm that is particularly well-suited for use in this type of “global” optimization problem. As will be discussed in detail below in association with the flowcharts of FIG. 4 and 5, SA works by replacing a current solution with another (random) solution that is ‘nearby’, testing the preference of one solution over the other. A given “temperature” variable To is decreased and the replacement is repeated, in each case saving the ‘best solution’. A random factor is introduced so that, at times, the “worse” solution is defined as the “best” solution. It is this continuing evaluation at ever-decreasing “temperatures” that gives this process the name “simulated annealing”.

As will also be discussed in detail below, most applications of SA include an inner DO-loop in which the temperature variable T₀ is held constant and the evaluation is repeated a number of times t, this sub-process referred to as “intensifying” the SA result at a given temperature. The use of this intensification aspect of the SA process is considered to be the preferred mode of practicing the method of the present invention.

With or without using the intensification, the result of the SA process in the method of the present invention is a cost-effective global solution to the problem of optimally locating POP facilities for a carrier, with respect to the customer base and access suppliers available to provide the connections. Indeed, it is a significant aspect of the present invention that the process of the present invention may be repeated in an on-going manner, as customer and/or supplier churn occurs (or as tariff rates change), to provide an ever-current optimal solution. Moreover, predictions and estimates of future demand may be incorporated into the process to allow for adequate growth within the carrier's network.

FIG. 3 contains a flowchart of an exemplary implementation of the k-means clustering process as identified in step 12 in the process of the present invention as outlined in the flowchart of FIG. 2. The process begins with the identified set of N total customer circuits (the term ‘circuit’ defining the customer telecommunications line to be connected to the carrier's network) and roughly partitions the N customer circuits into CL “clusters” by randomly assigning the individual customer circuits to the various clusters such that each cluster has essentially the same number of customer circuits (step 20). The centroid Cᵢ of each cluster is then calculated (step 22) as the mean of all the customer circuits within that cluster.

Following the calculation of this initial set of centroids, the process continues as outlined below to compare the location of each customer circuit with respect to the set of centroids, moving the customer circuit from one cluster to another (when required) such that each circuit is now in the cluster having the “closest” centroid. Referring to FIG. 3, the comparison process begins at step 24 by setting a MOVE counter to 0 and a CUSTOMER COUNTER (CC) to “1”. In step 26, the process continues by calculating the distance between (customer circuit)_{CC} and its currently-associated centroid C_{current}, setting this distance as d_{current} (step 28). Thereafter, the distance between (customer circuit)_{CC} and each remaining centroid {C₁, C₂, . . . , C_{CL}} is determined (step 30). A comparison is performed between d_{current} and each of the other distances (step 32), where if d_{current} is not the “shortest distance”, (customer circuit)cc is moved to the cluster associated with this shortest distance (step 34). For reasons that will become apparent below, the MOVE counter is incremented during this step (step 36).

Returning to comparison step 32, if d_{current} is the “shortest”, this means that (customer circuit)_{CC} is already located in its proper cluster and it will “stay” there (shown as step 38). The process continues from both steps 36 and 38 by incrementing the customer circuit counter (step 40) and performing a determination to see of each customer circuit has been through the distance-calculating process (step 42). Presuming that additional customer circuits remain, the process goes back to step 26, calculating the distance between the next customer circuit and its currently-associated cluster centroid, following through steps 28-42 as outlined above.

Once each customer circuit has been through the distance calculating process, the result of the comparison in step 42 will indicate that CC>N. At this point, a query is made regarding the number of customer circuit “moves” that have been made (step 44). In accordance with the k-means clustering process, if none of the customer circuits have been moved, then they are all associated with their “closest” centroid and are located in their proper cluster.

At least initially, it is presumed that the value of counter MOVE will be greater than zero (indicating that one or more customer circuits have been moved from one cluster to another). In accordance with the present invention, the process continues in this case by returning to step 22 and re-determining the centroid of each cluster (which will most likely change in some cases, since various ones of the customer circuits have been moved). The “customer circuit counter” CC is reset to one (step 24), and the distance process is re-calculated for each customer circuit (steps 26-44) as discussed above. This entire process will continue as long as at least one customer circuit has been moved during the distance comparison process (that is MOVE>0).

At some point in time, the customer circuits will all have been moved to the proper cluster and during a pass through then distance problem, the MOVE counter will remain at 0. Referring to step 44, when this occurs, the k-means clustering process is defined as being “completed” with the identification of each cluster (including its associated customer circuits) is returned to step 12 of the overall flowchart of FIG. 2. The overall process of the present invention then continues at step 14, with the use of a linear programming model to determine a minimal cost POP location arrangement for each cluster.

For the purposes of understanding the parameters involved in obtaining a minimal cost configuration, the following definitions are used (a per-cluster definition):
N—the finite set of customer circuits
F—the finite set of potential POP locations
S—the finite set of access suppliers
t—planning time horizon in “months”
fⱼ□ [symbol] —one-time cost for opening a POP facility at location j
f′ⱼ≡ [symbol] —monthly recurring charges for operating POP facility at location j
Cᵢⱼₖ≡ [symbol] —one-time cost for re-homing customer circuit i to POP facility j using access supplier k
Cᵢⱼₖ≡ [symbol] —monthly recurring charges for providing customer circuit i at POP facility j using access supplier k
xᵢⱼₖ—a binary variable that indicates if customer circuit i is connected to POP facility j via access supplier k (i.e., xᵢⱼₖ=1 if the circuit is connected to POP j via supplier k; xᵢⱼₖ=0 otherwise)
yⱼ—a binary variable that indicates if a POP facility is installed at location j
   In accordance with the present invention, the goal is to minimize the sum of the POP facility cost and customer circuit cost over a period of t months, using the above-defined factors. Inasmuch as the customer base has been clustered into manageable groups, linear programming can be used to perform this minimization on a cluster-by-cluster basis, evaluating the following relation:

$$Min {\sum }_{i ∉ N} {\sum }_{j ∈ F} {\sum }_{k ∈ S} ( {C}_{ijk} + {C}_{ijk}^{′} \cdot t ) {x}_{ijk} + {\sum }_{j ∈ F} ( {f}_{j} + {f}_{j}^{′} \cdot t ) {y}_{j} ,$$

subject to the following constraints:

$${\sum }_{j ∈ F} {\sum }_{k ∈ S} {x}_{ijk} = 1 ∀ i ∈ N$$

(each customer circuit served by exactly one POP via exactly one supplier); and

xᵢⱼₖ≦yⱼ ∀ i ε N, j ε F, k ε S (a customer circuit is assigned to a POP location j only if a POP is installed at location j).

Applying this linear programming model results in providing an initial set of POP facility locations Yᵢ for each cluster i of the plurality of CL clusters. The objective function value f for each cluster denotes the total cost incurred by providing service to the cluster customer base by the initial set of POP facilities Y.

The initial global solution for the entire set of POP facility locations, step 16, is then found by summing the above-created solutions for the CL clusters:

$${Y}_{initial} = {\sum }_{i = 1}^{CL} {Y}_{i} .$$

As mentioned above, it can be presumed that this initial solution to the problem of optimizing the location of a carrier's POP facilities is not optimized from a global perspective. Thus, the next step in the optimization process of the present invention is to perform a “simulated annealing” (SA) process on this initial result, where the number of iterations through the SA process (i.e., the number of ‘temperature’ decrements), as well as the inclusion of intensification at each temperature (if desired), will provide a final solution that will be an improved version of the POP location problem.

FIG. 4 contains a flowchart illustrating one version of the SA process that may be applied to optimizing the initial POP facility location assignment as defined by Yᵢₙᵢₜᵢₐₗ. As shown, the SA process begins (step 100) by initializing the following parameters: a “temperature count” t, which defines the number of temperatures to be used in the SA process; T₀, which is the initial “temperature”; k₁ defining the number of iterations to be performed at each temperature (the “intensification”); and k₂ defining an acceptable number of improved solutions at each temperature (k₂≦k₁). As will be described below, if ‘intensification’ is not used, k₁=1.

Continuing with the process itself, the next step is associated with initializing a pass through SA, by setting an initial intensification count, as well as an initial ‘improved solution’ count, at zero (step 102). Next, a random solution “near” the initial POP facility solution Yᵢₙᵢₜᵢₐₗ is created (step 104), in this case by using the neighborhood generating function N(·), where

N(Yᵢₙᵢₜᵢₐₗ)≡Y₁

The specific process used in this case to create the ‘near’ solution Y₁ will be discussed in detail hereinbelow in association with the flowchart of FIG. 5, which shows in the detail the steps used to create a solution using the neighborhood generating function. For the purposes of the present invention, “nearby” solutions are created by applying one of the following three operations to the initial set of POP facilities: “add”, “remove” or “swap” (where “swap” is defined as trading an open POP facility with a closed POP facility).

Given this proposed solution Y₁, the SA process continues, at step 106, by evaluating the objective function, determining the solution f(Y₁) using the above-described linear programming model and setting this solution equal to a parameter defined as the “current solution”, denoted as f_{CS} in step 108. Applying the SA technique, a value defined as δf is next found by subtracting the just-created current solution f_{CS} from the previously-known “best solution”f_{BS} (where this will be fᵢₙᵢₜᵢₐₗ in the first instance). Step 110 shows the generation of δf, where the next step 112 is a determination if δf is either non-negative or negative. If δf≧0, this means that the current solution is now accepted as the “best” solution. Referring to step 114, this acceptance then requires that Y₁ now replace Yᵢₙᵢₜᵢₐₗ as the “best” POP facility location solution, with the objective function f(Y₁) being defined as equal to f_{CBS}=f_{BS}.

The ‘best solution’ count parameter is then incremented in the next step (step 116), followed by a comparison in step 118 between the ‘best solution’ count and the predetermined value of k₂. If the current count is greater than k₂ (meaning that a satisfactory number of improved solutions has been found), the process exits from the intensification portion of the process and decrements the ‘temperature’ for the next round of intensification (as will be discussed in detail below).

Presuming that the current value of ‘best solution’ is less than k₂, the process as shown in FIG. 4 continues at step 120 with incrementing the iteration count and comparing (at step 122) against the predetermined iteration value k₁ (defining the number of iterations at a specific ‘temperature’—intensification). If the total number of iterations has been reached, the process again exits this intensification procedure, maintaining the last-generated ‘current solution’ results. If the total has not yet been reached, the process returns to step 104, which then creates a new ‘nearby’ neighborhood version of the current best solution and proceeds through all of the steps as outlined above.

Now referring back to the decision point at step 112, if the value of δf is negative, this means that the current-created solution is ‘worse’ than the previous solution. However, instead of just ignoring this solution, the SA process continues, as shown at step 124, with creating a random fraction r, where r ε |0,1|. The value of exp(δf/T₀) is then calculated and compared to the random fraction r in step 126. As set up in this embodiment, if the value of r is less than the calculated value, then the currently-created solution is accepted as the “current best solution” (step 128), even though it is actually “worse” than the previous solution. Referring to step 128, this action is shown by setting the “current best facility set” (CBFS) equal to solution Y₁, and f(Y₁)=f_{CBS}. It is to be noted that unlike the result step 114, this current result is not stored as either the “best facility solution” (BFS) or the best solution to the objective function value f_{BS}. Following step 128, the process proceeds to incrementing the “best solution count” in step 116 and thereafter continuing in the manner outlined above.

Returning to step 126, if the value of the random fraction r is greater than the calculated fraction value, the newly-created neighborhood solution Y₁ (the ‘worse’ value) is ignored, the process continues by incrementing the iteration count at step 120 and continuing with either the generation of a ‘new’ neighborhood result (if the number of iterations at this temperature is less than k₁) or exiting the intensification sub-process and moving to a lower ‘temperature’ for continuing the SA process.

Ultimately, when either k₁ or k₂ has been met (whichever comes first), the intensification portion of the SA process is considered as completed (for this specific “temperature”). The process then proceeds, as shown in step 130 by increasing the “temperature count” (that is, the number of annealing cycles to be employed in the optimization process). If the incremented value matches the predefined value k (step 132), the simulated annealing process is defined as “completed” and the final value of the “best solution” (BFS) is used as the optimized POP location assignment.

Otherwise, if the temperature count value remains less than the defined parameter k, the simulated annealing process continues to step 134, which generates a lower “temperature” parameter using the relation as shown. It is an aspect of the SA process that the reduction in ‘temperature’ will drop off quickly for the initial, large values of T₀ and thereafter proceed with smaller and smaller decrements (following the exponential decay). Once the new value of T₀ has been generated, the process returns to step 102, which will re-initialize the counts associated with the intensification process as this new “temperature”, and the entire SA process as outlined above will repeat itself.

As a variation to the use of a fixed number of temperature points to control the number of iterations through the SA process, it is also possible to evaluate the changes in “best facility solution” at the end of each set of intensifications. If it begins to appear that the solutions are varying in only a slight amount around median value, it can be concluded that a steady-state condition has been achieved and any of the most recently generated best solutions may be used.

FIG. 5 contains a flowchart illustrating an exemplary process for implementing the neighborhood generation function as used within the SA process outlined in FIG. 4. In accordance with the present invention, SA involves creating a ‘random’ variation of an initial solution, then comparing the random variation with the previous solution and selecting one or the other as a “current best”. The neighborhood generation function is a preferable process for creating such an alternative, “near-by” result that may be used for these comparison purposes. It is to be understood, however, that various other processes for creating a near-by ‘randomization’ of the initial solution Yᵢₙᵢₜᵢₐₗ may be employed in accordance with the teachings of the present invention. As mentioned above, this particular function is limited to providing only three different results: “open”, “closed” and “swap”. It is to be understood that other functions (or variations of this neighborhood generation function) may be used to create the “nearby” result for use in the SA process as outlined above.

Referring to FIG. 5, the neighborhood generation function begins with comparing the number of open POP facilities associated with Yᵢₙᵢₜᵢₐₗ to the total possible number of POP facilities available for the carrier's network (step 200). If |Y|≧J, the 10 decision is made (step 202) to remove one open POP facility (selected at random) and define the newly-created set as the “neighborhood-generated” result Y₁. The new set Y₁ is then returned to step 106 of the flowchart of FIG. 4 to be used in the above-described SA process.

If |Y|<J, the neighborhood generation process continues by generating a random fraction r (r ε |0,1|), as shown in step 204. At step 206, the current value |Y| is compared to “1” (i.e., is there only “one” open POP facility in the current network solution). If |Y|≦1, the process continues to step 208, which makes a determination of the value of r versus the range of 0.0 and 0.7. If r is in this range, the neighborhood generation function performs the step of “swapping” one open POP facility with one 20 closed POP facility (step 210), returning the updated set as the “new” set Y₁ to step 106 of the SA process. Alternatively, if the current random value of r is not within the defined range, the process continues to step 212, which adds one closed POP facility to the list of open facilities, returning this increased set of POP facilities as Y₁ to step 106 of the SA process.

Returning to step 206, if the current value of |Y| is greater than 1, the process continues to a comparison step 214, where the value of r is compared to the defined range of 0-0.5. If the current value of r is found to be in this range, the process moves to step 210 and performs the “swapping” function. Otherwise, a further comparison is made in step 216 to determine if the value of r is within the range of 0.5 to 0.7. If r is within this range, the process moves to step 212 and “adds” one more POP facility to the list of open facilities. Otherwise, if r is greater than 0.7, one of the open POP facilities is “removed” from the current list (step 218), with this result being returned as new result Y₁ to step 106 of the SA process.

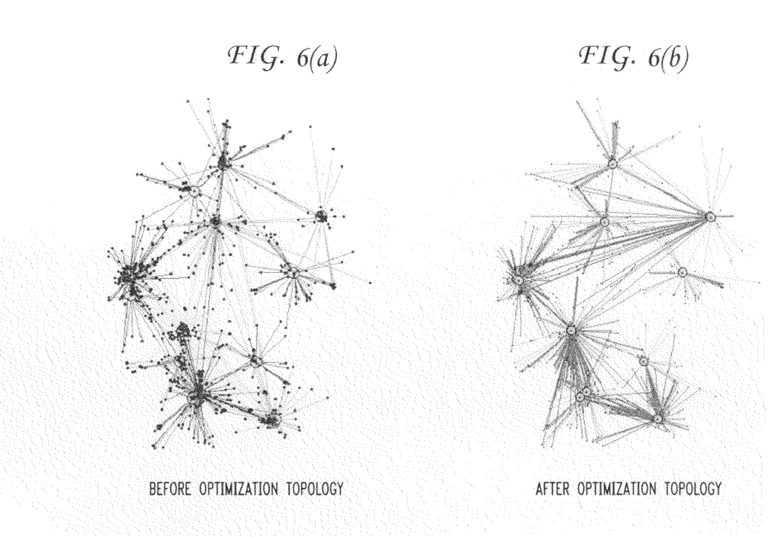

FIG. 6 contains a diagram illustrating the savings associated with applying the optimization strategy to an exemplary carrier network arrangement. FIG. 6(a) illustrates an exemplary arrangement of network POPs, with a set of designated suppliers and customer circuit locations. FIG. 6(b) illustrates an optimum deployment of POP facilities and associated access suppliers to supply the same customer base configured using the process of the present invention. In this case, there were a total of approximately 2250 customer circuits, with the arrangement in FIG. 6(a) having a total of 16 POP facility locations. The optimized arrangement, as shown in FIG. 6(b) retained 6 of the original POPs, closing the remaining 10 and opening three new POP locations. This modification was found to reduce the monthly recurring costs by about 37%.

As evident from the results illustrated in FIG. 6, the utilization of a simulated annealing process in conjunction with clustering the customers results in re-configuring the POP location problem into an arrangement that can be studied such that a cost-efficient deployment of POP locations can be made (and changed, as conditions warrant). In particular, the results of applying the method of the present invention provides the locations of the POPs, identifies the customer circuits that are homed on each of the POPs and the access suppliers used to provide the connections. Detailed network topologies, as shown in FIG. 6, can be visualized via GIS software. Financial impacts and associated charges in access suppliers can be directly determined from the data generated by the inventive method. Indeed, various ones of the identified suppliers, POPs or associated costs may be modified and the inventive method re-applied to allow for a network designer to assess different alternatives and perform some what-if analysis, which was heretofore prohibitively expensive and time-consuming.

Inasmuch as the present invention is subject to many variations, modifications and changes in detail, it is intended that all matter described throughout this specification and shown in the accompanying drawings be interpreted as illustrative only and not in a limiting sense. Accordingly, it is intended that the invention be limited only by the spirit and scope of the claims appended hereto.

What is claimed is:

1. A method of optimizing the placement of a network carrier's “Point of Presences” (POPs) facility locations across a communication network, the method comprising the steps of:
a) identifying a plurality of N customer facilities to be served by the network carrier, a plurality of F potential POP facility locations and a plurality of S access suppliers available for providing communication between the customer facilities and the POP facilities;
b) creating an initial solution Yᵢₙᵢₜᵢₐₗ for associating each customer facility with a POP facility location through an access supplier; and
c) performing simulated annealing on the initial solution Yᵢₙᵢₜᵢₐₗ for a predetermined number of iterations to achieve an optimized placement solution for the plurality of POP facility locations.

2. The method as defined in claim 1, wherein the initial solution is created by:
partitioning the plurality of N customer facilities into a set of CL clusters;
forming a locally optimized POP facility location solution for each cluster; and combining the set of CL locally optimized solutions to form the initial solution Yᵢₙᵢₜᵢₐₗ.

3. The method as defined in claim 2, where in performing the partitioning, each cluster is formed to have approximately the same number of customer facilities therein.

4. The method as defined in claim 2, where in performing the locally optimized POP facility location the follow steps are performed:
applying a linear algorithm process to obtain a minimal cost solution for the placement of at least one POP facility to service the customers within the cluster using a selected access supplier, for a given cluster i, the minimal cost solution defined as y(i) and the identified at least one POP facility defined as Yᵢ.

5. The method as defined in claim 2 wherein the plurality of N customer facilities are geographically partitioned into a plurality of CL separate customer clusters.

6. The method as defined in claim 1 wherein a k-means clustering process is used to form a plurality of CL separate customer clusters.

7. The method as defined in claim 6, wherein the k-means clustering process comprises the steps of:
i) randomly assigning each customer to a cluster;
ii) calculating the centroid C of each cluster;
iii) for each customer facility, determining the closest centroid and, if the closest centroid is within a different cluster, moving the customer facility to that cluster;
iv) repeating steps ii) and iii) until each customer facility is located in its closest cluster and no additional moves are performed in step iii); and
v) defining the results of step iv) as the k-means clustering solution.

8. The method as defined in claim 4, wherein the following analysis is performed separately for each cluster in the plurality of CL clusters:
$$Min {\sum }_{i ∉ N} {\sum }_{j ∈ F} {\sum }_{k ∈ S} ( {C}_{ijk} + {C}_{ijk}^{′} \cdot t ) {x}_{ijk} + {\sum }_{j ∈ F} ( {f}_{j} + {f}_{j}^{′} \cdot t ) {y}_{j} ,$$
where Cᵢⱼₖ is the initial cost for providing service to customer circuit i to POP location j via supplier k, Cᵢⱼₖ is the recurring costs for the same, t is the time period, fⱼ is the initial cost for installing a POP facility at location j and f′ⱼ is the recurring costs for maintaining a POP facility at location j.

9. The method as defined in claim 8 wherein the analysis includes the following constraints:
$${\sum }_{j ∈ F} {\sum }_{k ∈ S} {x}_{ijk} = 1 ∀ i ∈ N$$
such that each customer circuit served by exactly one POP facility via exactly one access supplier; and
xᵢⱼₖ≦yⱼ ∀ i ε N, j ε F, k ε S, such that a customer circuit is assigned to a POP facility j facility only if a POP facility is installed at location j.

10. The method as defined in claim 1, wherein in performing step c), the following steps are performed:
i) creating an alternative, nearby solution Y₁ relative to the initial solution Yᵢₙᵢₜᵢₐₗ generated in step e);
ii) determining the minimal cost solution f(Y₁) for nearby solution Y₁ of step i);
iii) comparing the difference between f(Y₁) and f(Yᵢₙᵢₜᵢₐₗ) and, if Y₁ provides a lower cost, replace Yᵢₙᵢₜᵢₐₗ with Y₁ and move to step v), otherwise
iv) performing a random operation to determine if Y₁ should replace Yᵢₙᵢₜᵢₐₗ as the lower cost solution; and
v) repeating steps i)-iv) until an optimized solution is achieved.

11. The method as defined in claim 10 wherein in performing step v), the process is repeated for a predetermined number of iterations.

12. The method as defined in claim 10 wherein in performing step v), the process is repeated until a minimal difference between Y₁ and Yᵢₙᵢₜᵢₐₗ is achieved.

13. The method as defined in claim 10, wherein in performing step i), a neighborhood generation function is used to create the alternative, nearby solution.

14. The method as defined in claim 13 wherein the neighborhood generation function comprises the following steps:
if the total number of POP facility locations is equal to plurality of F potential POP facility locations, removing a random POP facility and defining the result as nearby solution Y₁; otherwise,
generating a random fraction between zero and one; and, for a random fraction in a first interval,
if the total number of POP facilities is greater than one, exchanging an open POP facility for a closed POP facility to create nearby solution Y₁, otherwise
if the random fraction is within a second interval, adding one closed POP facility to the plurality of open POP facilities to create nearby solution Y₁, otherwise
if the random fraction is within a third interval, exchanging an open POP facility for a closed POP facility to create nearby solution Y₁, otherwise
if the random fraction is within a fourth interval, adding one closed POP facility to the plurality of open POP facilities to create nearby solution Y₁, otherwise
removing one open POP facility to create nearby solution Y₁.

15. The method as defined in claim 10, wherein steps iii)-v) are repeated at a predetermined temperature variable T₀ for a predefined number of t cycles, providing intensification of the solution.

16. The method as defined in claim 15 wherein the number of cycles is shorted to be less than t if a predetermined number k₂ nearby solutions are selected as preferred solutions.

17. The method as defined in claim 15, wherein for each repetition of steps iii)-v) the temperature variable T₀ is modified as follows:
$${T}_{0} = \frac{{T}_{0}}{1 + β {T}_{0}} ,$$
where
β is a predetermined fractional value.
